(19) United States
(12) Patent Application Publication
(10) Pub. No.: US 2014/0108118 A1
(43) Pub. Date: Apr. 17, 2014

(54) METHOD, SERVER AND SYSTEM FOR RELEASING A COMMODITY

(71) Applicant: Tencent Technology (Shenzhen) Company Limited, Shenzhen City (CN)

(72) Inventor: Li LI, Shenzhen City (CN)

(73) Assignee: Tencent Technology (Shenzhen) Company Limited, Shenzhen City (CN)

(21) Appl. No.: 14/138,174

(22) Filed: Dec. 23, 2013

Related U.S. Application Data
(63) Continuation of application No. PCT/CN2012/086626, filed on Dec. 14, 2012.

(30) Foreign Application Priority Data
Feb. 7, 2012 (CN) 2012100264814

(51) Int. Cl. G06Q 30/02

(52) U.S. Cl. CPC G06Q 30/0225
USPC 705/14.26

(57) ABSTRACT

According to an embodiment, a computer-implemented method for releasing a commodity is provided comprising: receiving commodity information from a client by a server; querying in a database, by the server, commodity order information corresponding to the commodity within a predetermined time period; obtaining, by the server, an average price for the commodity based on the commodity order information; and sending the average price and/or a price cut extent to the client by the server.

### CROSS REFERENCE TO RELATED APPLICATIONS

This application is a continuation application of the PCT application PCT/CN2012/086626, which claims priority from Chinese patent application No. 201210026481.4. The aforementioned applications are hereby incorporated by reference in their entirety.

### TECHNICAL FIELD

The present disclosure relates to electronic commerce, and in particular to method, server and system for releasing a commodity.

### BACKGROUND

In practice of electronic commerce, seller websites as electronic commercial platforms often launch activities of time-limited sales promotion. Before such activities, sellers using that platform should register commodities, and typically average price and price cut extent for the registered commodities should be obtained in advance. The purpose is, in one aspect, to rank the registered commodities based on the price cut extent, and in another aspect to display the average price and price cut extent for the registered commodities on a page of the seller website to attract customers by the advantageous price cut extent. Traditionally the seller is required to fill the average price and price cut extent at the same time of registering the commodities.

However, in order to have a better rank or to better attract customers, a seller may practice fraud in filling to exaggerate the price cut extent, and thus affect the objectiveness and authenticity of data.

### SUMMARY

It is desired to provide a method for releasing a commodity that would allow potential buyers to obtain the price cut extent for the commodity truly and accurately.

In an embodiment, a computer-implemented method for releasing a commodity is provided comprising: receiving commodity information from a client by a server; querying in a database, by the server, commodity order information corresponding to the commodity within a predetermined time period; obtaining, by the server, an average price for the commodity based on the commodity order information; and sending the average price and/or a price cut extent to the client by the server.

In another embodiment, a server for releasing a commodity is provided comprising: a receiving module for receiving commodity information from a client; a querying module for querying, in a database, commodity order information corresponding to the commodity within a predetermined time period; a processing module for obtaining an average price for the commodity based on the commodity order information; and a feedback module for sending the average price and/or a price cut extent to the client.

In a further embodiment, a system for releasing a commodity is provided comprising the server according to any of the aforementioned embodiments and the client.

According to the above method, server and system for releasing a commodity, a seller client first submit commodity information to a server of a seller website. The server then queries commodity order information corresponding to the commodity within a predetermined time period, in a database according to the commodity information, and processes the commodity order information to obtain an average price and price cut extent for the commodity. Commodity orders objectively reflect selling of commodities, and thus an objective average price can be obtained from commodity order information. The seller is not required to fill the average price and price cut extent when releasing the commodity, and the system automatically obtains the average price and price cut extent from the commodity order information. Therefore with the above method, server and system, fraud of the seller can be effectively prevented, and a true and accurate price cut extent is provided.

### BRIEF DESCRIPTION OF THE DRAWINGS

FIG. 1 illustrates a flowchart of a method for releasing a commodity according to an embodiment of the invention;

FIG. 2 illustrates a flowchart of an embodiment in which a server processes commodity order information to obtain an average price and price cut extent for a commodity;

FIG. 3 shows a scene in which the method for releasing a commodity according to an embodiment is applied;

FIG. 4 illustrates a flowchart for processing a data request by a server according to an embodiment;

FIG. 5 illustrates a flowchart for processing a search request by a server according to an embodiment;

FIG. 6 illustrates a structure of a system for releasing a commodity according to an embodiment;

FIG. 7 illustrates a structure of a processing module in an embodiment;

FIG. 8 illustrates a structure of a system for releasing a commodity according to an embodiment;

FIG. 9 illustrates a structure of a system for releasing a commodity according to an embodiment; and

FIG. 10 is a block diagram showing exemplary internal components of the server according to the embodiments of the disclosure.

### DETAILED DESCRIPTION OF THE EMBODIMENTS

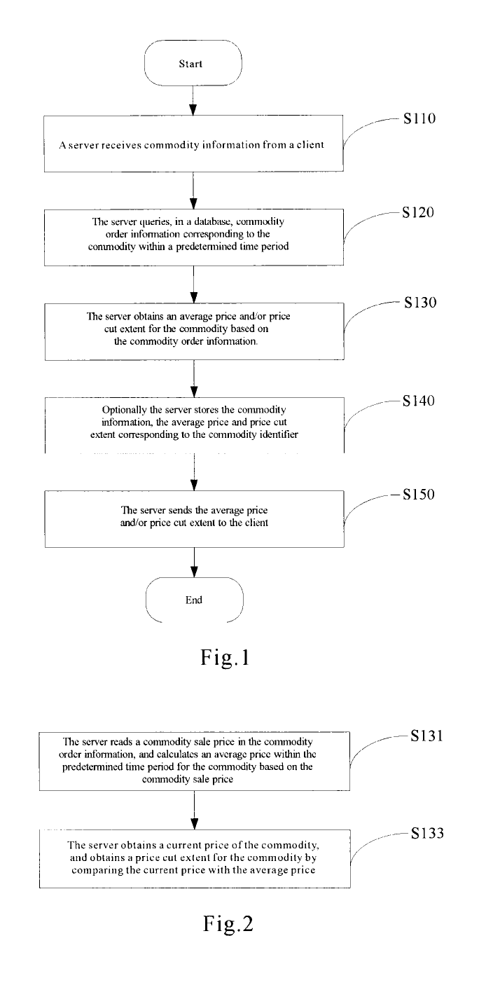

As shown in FIG. 1, in an embodiment, a computer-implemented method for releasing a commodity is provided. The method may comprise carrying out the following steps by a server of a seller website.

In step S110, a server receives commodity information from a client.

If a user (a potential buyer) expects to know the price cut condition of the commodity to determine whether to buy the commodity, he/she may submit the commodity information about the commodity to the server by the client. In an embodiment, the commodity information may comprise a commodity identifier of the commodity. Moreover, the commodity information may comprise a current price of the commodity, a description of the commodity, and a sold amount of the commodity. The current price may be a price filled by a seller when registering the commodity. The seller may select a commodity identifier for the commodity when submitting the commodity for release; alternatively, the server may automatically select the commodity identifier based upon information of the commodity. On a single electronic commercial platform, same commodity may be assigned with same commodity identifier.

In step S120, the server queries, in a database, commodity order information corresponding to the commodity within a predetermined time period.

The server will store commodity order information in the database when a commodity order is processed. Upon receiving the commodity information, the server may retrieve the commodity order information corresponding to the commodity from the database based on the commodity information.

When commodity order information is to be obtained, the server may retrieve commodity order information within a predetermined time period. If a too long time period is selected, the retrieved data may include information out of date. On the other hand, if a too short time period is selected, the retrieved data may be not representative but stray. In specific embodiments, the time period may be set based on practical requirements, and may be set to one week or one month for example.

In step S130, the server may obtain an average price and/or price cut extent for the commodity based on the commodity order information.

As shown in FIG. 2, in an embodiment, step S130 may comprise the following steps.

In step S131, the server may read a commodity sale price in the commodity order information, and calculate an average price within the predetermined time period for the commodity based on the commodity sale price. The average price may be an average value of the read commodity sale price.

In step S133, the server may obtain a current price of the commodity, and obtain a price cut extent for the commodity by comparing the current price with the average price. The price cut extent may be a difference between the current price and the average price for the commodity. For example, if the server has obtained the commodity order information within recent 10 days, based on which the average price was calculated to be 80 dollars, and the current price of the commodity is 60 dollars, then the price cut extent for the commodity is calculated as 20 dollars.

In an embodiment, the method may further comprise, prior to step S131, determining whether the database stores therein a history average price of the commodity. If so, the server may obtain the history average price as the average price, and carry out step S133 to obtain the current price of the commodity and obtain the price cut extent by comparing the current price against the history average price. Otherwise step S131 is to be carried out, whereby the server will read the prices in the commodity order information and obtain the average price of the commodity within the predetermine time period based on the prices.

A commodity may be involved in a recent time period and thus the server may have stored the average price of the commodity in the database. If there is the average price, then it may be obtained directly for the calculation of the price cut extent, without the need of obtaining the commodity order information again and calculating the average price. This will reduce the operation burden on the server and improve the operation efficiency.

The method may comprise an optional step S140 in which the server may store the commodity information, the average price and price cut extent corresponding to the commodity identifier.

In particular, the server stores commodity information submitted from clients, and the stored commodity information may be invoked upon a data request being received from a client. In the embodiment, the server may store the average price, price cut extent and commodity identifier in a corresponding manner. The server may further return the average price and price cut extent to the client when returning the commodity information published by the seller in response to the data request from the client.

In step S150, the server sends the average price and/or price cut extent to the client. The client may carry out presentation based on what it received.

In particular, the client may obtain the commodity information, the average price and price cut extent corresponding to the commodity identifier from the client. Further, the average price and price cut extent corresponding to the commodity identifier may be displayed on a seller page or another application page (e.g. a search page). In this way, the buyer may directly see the average price and price cut extent for the commodity, both of which are true and accurate.

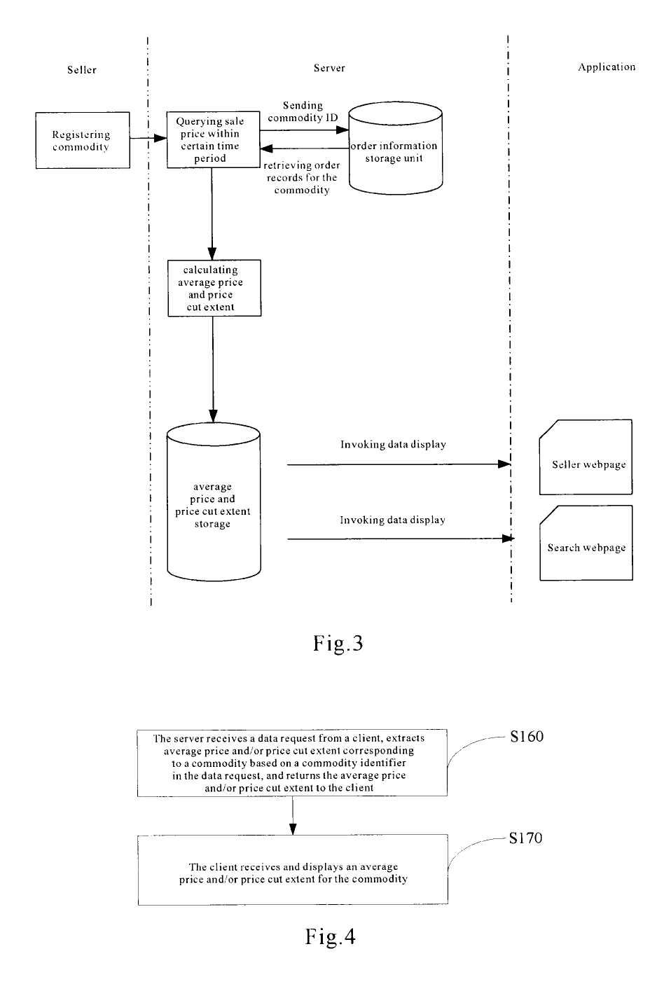

With reference to FIG. 3, the method for releasing a commodity will be described in connection with an exemplary scene where it is applied. In the embodiment, a seller registers a commodity and submits commodity information. The server obtains a commodity identifier in the commodity information, retrieves order records for the commodity from an order information storage unit in a database and queries prices for the commodity within a past predetermined time period from the order records. The server then automatically calculates an average price and price cut extent for the commodity in accordance with step S130 described above, and stores the average price and price cut extent into an average price and price cut extent storage unit of the database.

Further, the data in the average price and price cut extent storage unit are invoked for display depending on different data requests in different application contexts. For instance, when a user views a seller webpage, the average price and price cut extent are displayed in the seller webpage. In another embodiment, when a commodity is searched, the average price and price cut extent may be displayed in a search page.

As shown in FIG. 4, in an embodiment, the method for releasing a commodity may comprise the following steps.

In step S160, the server receives a data request from a client, extracts average price and/or price cut extent corresponding to a commodity based on a commodity identifier in the data request, and returns the average price and/or price cut extent to the client.

For example, when a user is browsing, with his/her client, a webpage of a seller on a seller website and viewing a commodity released by the seller on the webpage, he/she may want to obtain an average price and/or price cut extent for the commodity. The client may send a data request to the server for obtaining the average price and/or price cut extent and the data request may include a commodity identifier for the commodity, then the server may extract the stored average price and/or price cut extent corresponding to the commodity identifier from the database based on the commodity identifier.

In step S170, the client may receive and display an average price and/or price cut extent for the commodity.

In particular, after receiving the average price and/or price cut extent for the commodity, the client may display at corresponding positions according to user's need.

As shown in FIG. 5, in another embodiment, a method for releasing a commodity may comprise the following steps.

In step S260, a server receives a search request form a client, and searches for a commodity search result that matches a keyword in the search request based on the keyword.

For example, a user may be interested in a certain commodity or commodities of a certain type. He/she may send a search request to the server with a keyword for the commodity of interest, and the server will search in commodity information in a database based on the search request and the keyword to obtain a commodity search result that matches the keyword.

In step S270, a corresponding average price and price cut extent may be extracted based on a commodity identifier in the commodity search result, and returned to the client.

The server may obtain a commodity identifier from commodity information in the commodity search result. Since average prices and price cut extents are stored corresponding to commodity identifiers, the average price and price cut extent for each of the searched commodities can be obtained based on its commodity identifier, and then the average price and price cut extent are fed to the client.

In step S280, the commodity search result is displayed on the client along with the corresponding average price and price cut extent.

After obtaining the commodity search result as well as the average price and price cut extent, the client displays the commodity search result along with the average price and price cut extent corresponding to the search result. Moreover, the commodity search result may be sorted in order of price cut extent on the client to facilitate the user's view.

Alternatively, the commodity search result obtained in step S260 may serve as the commodity information in step S110 of FIG. 1 to thereby carry out the method shown in FIG. 1.

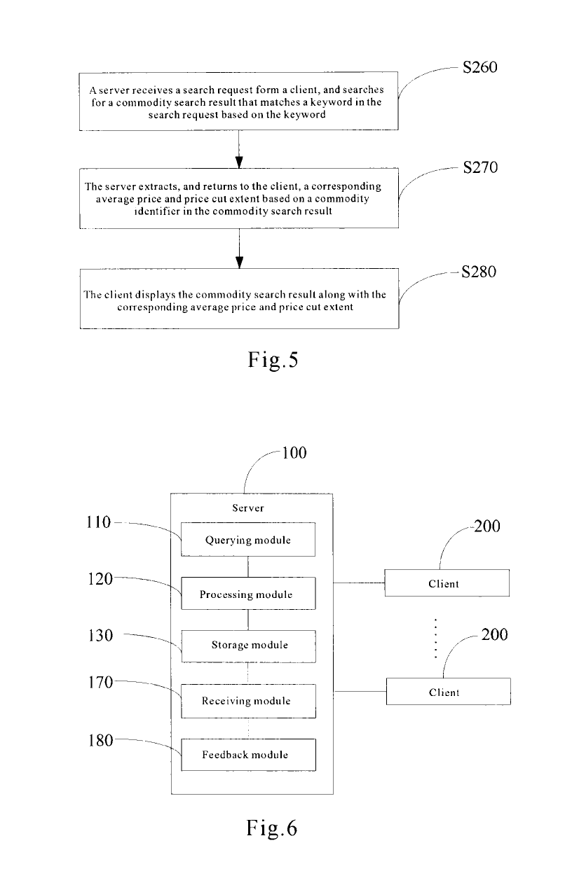

As shown in FIG. 6, a system for releasing a commodity is further provided. The system comprises a server 100 and one or more clients 200. The server 100 may comprise a querying module 110, a processing module 120, a storage module 130, a receiving module 170 and a feedback module 180.

The client 200 is operable to submit commodity information to the server 100.

In an embodiment, the commodity information comprises a current price and a commodity identifier for the commodity. Additionally or alternatively, the commodity information may comprise description of the commodity, sold amount of the commodity, etc. The current price is the price filled by the seller upon registering the commodity. When submitting on the client 200 the commodity to be released, the seller may select a commodity identifier for the commodity, or the server may automatically select a commodity identifier based on the commodity information. On a single electronic commercial platform, same commodity may be assigned with same commodity identifier.

The receiving module 170 is operable to receive the commodity information submitted from the client 200.

The querying module 110 is operable to query commodity order information corresponding to the commodity identifier within a predetermined time period in the database based on the commodity information.

Order information for sold commodities is stored in the database of the system. When the commodity information is obtained, the querying module 110 may obtain the commodity order information for the corresponding commodity from the database based on the commodity identifier.

When commodity order information is to be obtained, the querying module 110 may retrieve commodity order information within a predetermined time period. If a too long time period is selected, the retrieved data may include information out of date. On the other hand, if a too short time period is selected, the retrieved data may be not representative but stray. In specific embodiments, the time period may be set based on practical requirements, and may be set to one week or one month for example.

The processing module 120 is operable to process the commodity order information to obtain the average price and price cut extent for the commodity.

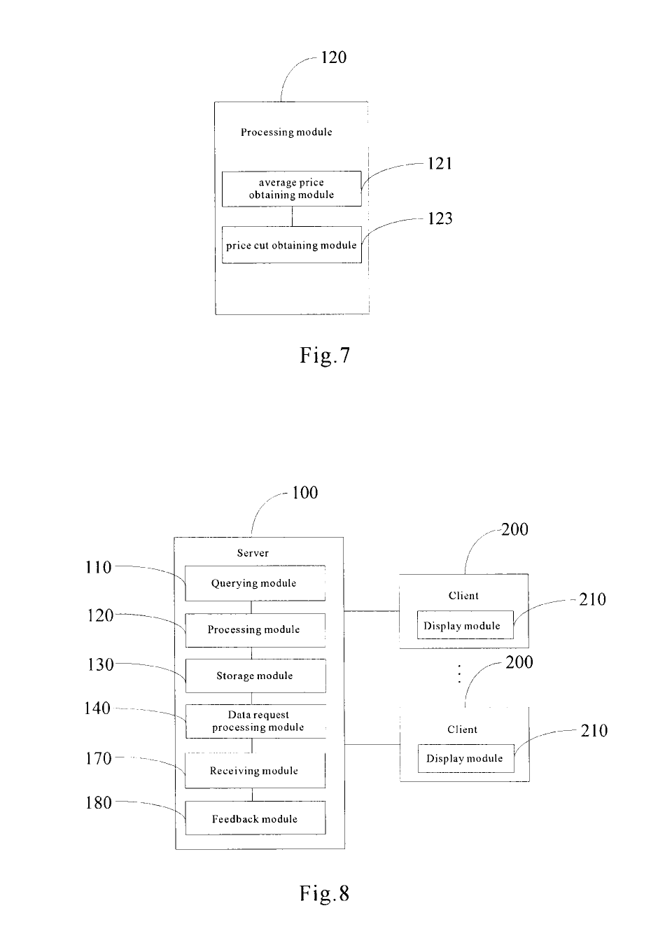

As shown in FIG. 7, in an embodiment, the processing module 120 may comprise an average price obtaining module 121 and a price cut extent obtaining module 123.

The average price obtaining module 121 is operable to read a commodity sale price in the commodity order information, and calculate an average price within the predetermined time period for the commodity based on the commodity sale price. The average price may be an average value of the read commodity sale price.

The price cut extent obtaining module 123 is operable to obtain a current price of the commodity, and obtain the price cut extent for the commodity by comparing the current price with the average price.

In particular, the price cut extent may be a difference between the current price and the average price for the commodity. For example, if the server has obtained the commodity order information within recent 10 days, based on which the average price was calculated to be 80 dollars, and the current price of the commodity is 60 dollars, then the price cut extent for the commodity is calculated as 20 dollars.

In an embodiment, the processing module 120 may further comprise a determining module (not shown) for determining whether the average price exists in the database. If so, it informs the price cut extent obtaining module 123 to obtain the current price of the commodity and to obtain the price cut extent for the commodity by comparing the current price with the average price; otherwise it informs the average price obtaining module 121 to read the commodity sale price in the commodity order information, based on which the average price for the commodity within the predetermined time period is calculated.

A commodity may be involved in a recent time period and thus the server may have stored the average price of the commodity in the database. If there is the average price, then the price cut extent obtaining module 123 may obtain the current price and the average price directly for the calculation of the price cut extent, without the need of obtaining the commodity order information by the average price obtaining module 121 and calculating the average price again. This will reduce the operation burden on the server and improve the operation efficiency.

The storage module 130 is operable to store the commodity information, the average price and price cut extent corresponding to the commodity identifier.

In particular, the storage module 130 stores commodity information submitted from clients, and the stored commodity information may be invoked upon a data request being received from a client. In the embodiment, the storage module 130 may store the average price, price cut extent and commodity identifier in a corresponding manner. The storage module 130 may further return the average price and price cut extent to the client 200 when returning the commodity information published by the seller in response to the data request from the client.

The feedback module is operable to feed the commodity information, the average price and price cut extent corresponding to the commodity identifier to the client. Further, the client may be operable to obtain, from the server 100, and present the commodity information, the average price and price cut extent corresponding to the commodity identifier.

As shown in FIG. 8, in an embodiment, the server 100 of the system for releasing a commodity further comprises data request processing module 140, and the client 200 further comprises a display module 210.

The data request processing module 140 is operable to receive a data request from the client 200, extract the average price and price cut extent for a corresponding commodity based on the commodity identifier in the data request, and invoke the feedback module 180 to return the corresponding average price and price cut extent to the client 200.

For example, as a user browses a seller webpage on the client 200 and views on the webpage a commodity released by the seller, he/she may want to obtain an average price and price cut extent for the commodity. The client 200 thus sends to the data request processing module 140 a data request for the average price and price cut extent for the commodity, and the request comprises the commodity identifier for the commodity. The data request processing module 140 can extract, from the database, the average price and price cut extent that are stored corresponding to the commodity identifier.

The display module 210 is operable to receive and display the average price and price cut extent for the corresponding commodity.

In particular, after the client 200 receives the average price and price cut extent for the corresponding commodity, the display module 210 may display on a corresponding position depending on the user's need.

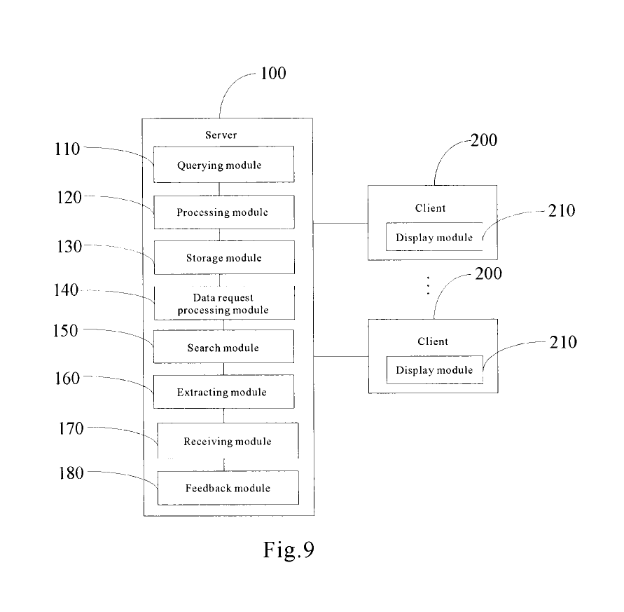

As shown in FIG. 9, in another embodiment, the server 100 may further comprise a search module 150 and an extracting module 160. The client 200 may comprise a display module 210.

The search module 150 is operable to receive a search request from the client 200, and search for a commodity search result that matches a keyword in the search request based on the keyword.

For example, a user may be interest in a certain type of commodity and send a search request to the server via the client, along with a keyword for the commodity of interest. The server may search in the commodity information in the database based on the search request and the keyword to obtain a commodity search result that matches the keyword.

The extracting module 160 is operable to extract an average price and a price cut extent based on a commodity identifier in the commodity search result, and invoke the feedback module 180 to send the average price and the price cut extent back to the client.

The extracting module 160 may first obtain the commodity identifier from the commodity information in the commodity search result. Since the average price and price cut extent are stored corresponding to the commodity identifier, the extracting module 160 can obtain the average price and price cut extent for each commodity in the commodity search result based on the commodity identifier and feedback the average price and price cut extent to the client.

The display module 210 is operable to display the commodity search result and display the average price and the price cut extent for the commodity.

After the client 200 receives the commodity search result, the average price and the price cut extent, the display module 210 may display the commodity search result, and display the average price and the price cut extent for the commodity. In addition, the commodity search result may be sorted on the client 200 in order of price cut extent on the client to facilitate the user's view.

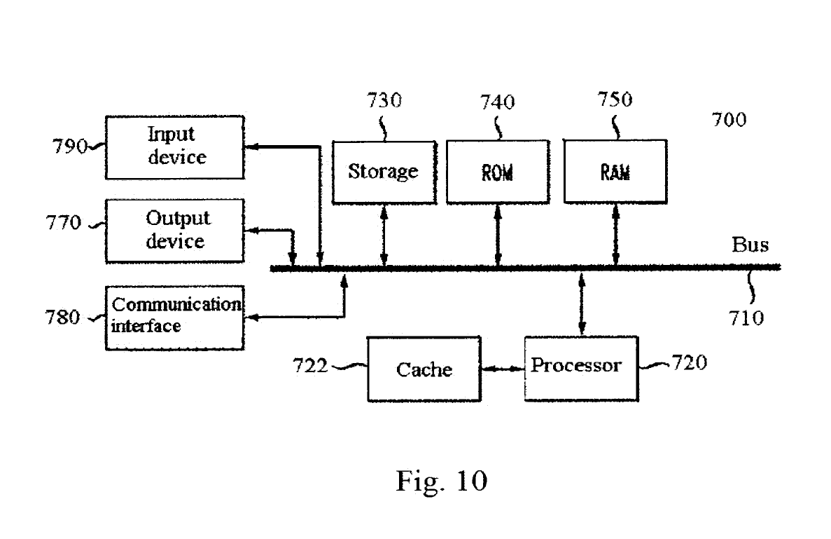

FIG. 10 is a block diagram showing exemplary internal components of the server 100 according to the embodiments of the disclosure. The server 100 may comprise a bus 710 coupling various components as described below. The server 100 may comprise a processor 720, which may be one or more central processing unit(s) each having one or more processing cores, graphical processing unit(s) or other processing element(s). The server 100 may comprise a cache 722 coupled to the processor 720 or integrated as a part of the processor 720. The server 100 may comprise a system memory, for example read only memory (ROM) 740 and random access memory (RAM) 750. The server 100 may further comprise a storage 730, which may be a non-volatile computer-readable medium, such as an optical disk, a magnetic disk (e.g. hard disk or floppy disk), an opto-magnetic disk, a flash memory, and the like. Data may be copied to the cache 722 from storage 730, ROM 740 or RAM 750 to avoid delay in the processor 720 waiting for data and to thereby improve the overall performance. The server 100 may further comprise an input device 790 and an output device 770 for interaction between a user and the server 100. The input device 790 may be, for example, keypad, mouse, motion input, image capturing element, gravity sensor, voice receiving element, and so on. The output device 770 may be common output mechanisms as well known for those skilled in the art, e.g. speaker, beeper, flash light, image projecting element, vibration output element, or a further display screen. The server 100 may comprise a communication interface 780 for data communication in a wired or wireless manner.

According to the above method and system for releasing a commodity, a potential buyer may submit commodity information via his/her client to send the commodity information to the server of the seller website. The server may query commodity order information corresponding to the commodity identifier within a predetermined time period in the database according to the commodity information, and process the commodity order information to obtain the average price and price cut extent for the commodity. The commodity order information objectively reflects the sales of the commodity, and thus an objective average price can be obtained from the commodity order information. The seller does not need to fill the average price and price cut extent when releasing the commodity; rather, the system automatically obtains the average price and price cut extent from the commodity order information. Therefore, Therefore with the above method and system, fraud of the seller can be effectively prevented, and a true and accurate price cut extent is provided.

The inventive disclosure has been described above in terms of specific embodiments which, however, are not intended to limit the scope of the inventive concept. Those skilled in the art may make various modifications and improvements without departing from the spirit and concept of the invention which is solely defined by the appended claims.

What is claimed is:

1. A computer-implemented method for releasing a commodity, comprising:
receiving commodity information from a client by a server;
querying in a database, by the server, commodity order information corresponding to the commodity within a predetermined time period;
obtaining, by the server, an average price for the commodity based on the commodity order information; and
sending the average price and/or a price cut extent to the client by the server.

2. The method according to claim 1, wherein the commodity information comprises at least one of: a commodity identifier of the commodity, a current price of the commodity, a description of the commodity, and a sold amount of the commodity.

3. The method according to claim 1, wherein the database stores therein a history average price of the commodity, and the server obtains the history average price as the average price.

4. The method according to claim 1, further comprising:
presenting the average price and/or the price cut extent by the client.

5. The method according to claim 1, wherein the commodity information is obtained by:
receiving a search request from the client by the server, and searching for a commodity search result that matches a keyword in the search request based on the keyword.

6. A server for releasing a commodity, comprising:
a receiving module for receiving commodity information from a client;
a querying module for querying, in a database, commodity order information corresponding to the commodity within a predetermined time period;
a processing module for obtaining an average price for the commodity based on the commodity order information; and
a feedback module for sending the average price and/or a price cut extent to the client.

7. The server according to claim 6, wherein the processing module comprises:
an average price obtaining module for reading a commodity sale price in the commodity order information, and calculating an average price within the predetermined time period for the commodity based on the commodity sale price; and
a price cut extent obtaining module for obtaining a current price of the commodity, and obtaining the price cut extent for the commodity by comparing the current price with the average price.

8. The server according to claim 7, wherein the processing module further comprises:
a determining module for determining whether the average price exists in the database, and,
if so, informing the price cut extent obtaining module to obtain the current price of the commodity and to obtain the price cut extent for the commodity by comparing the current price with the average price, and
if not, informing the average price obtaining module to read the commodity sale price in the commodity order information.

9. A system for releasing a commodity, comprising:
the server according to claim 6, and
the client.

10. The system according to claim 9, wherein
the server further comprises a data request processing module for receiving a data request from the client, extracting the average price and price cut extent for the commodity corresponding to a commodity identifier in the data request based on the commodity identifier, and invoking the feedback module to send the average price and the price cut extent back to the client, and
the client further comprises a display module for receiving and displaying the average price and the price cut extent for the commodity.

11. The system according to claim 9, wherein
the server further comprises:
a search module for receiving a search request from the client, and searching for a commodity search result that matches a keyword in the search request based on the keyword; and
an extracting module for extracting an average price and a price cut extent based on a commodity identifier in the commodity search result, and invoking the feedback module to send the average price and the price cut extent back to the client, and
the client further comprises a display module for displaying the commodity search result and displaying the average price and the price cut extent for the commodity.
